(19) United States
(12) Patent Application Publication
(10) Pub. No.: US 2002/0063023 A1
(43) Pub. Date: May 30, 2002

(54) Digressive piston compression valve

(75) Inventors: Jamshid K. Moradmand, Dayton, OH (US); Marcin Knapczyk, Krakow (PL); Glen W. Spehr, Huber Heights, OH (US)

Correspondence Address: DELPHI TECHNOLOGIES, INC., Legal Staff, Mail Code: 482-204-450, 1450 W. Long Lake, P.O. BOX 5052, Troy, MI, 48098, US

(73) Assignee: DELPHI TECHNOLOGIES INC.

(21) Appl. No.: 10/002,766

(22) Filed: Nov. 30, 2001

Related U.S. Application Data
(60) Provisional application No. 60/250,319, filed on Nov. 30, 2000.

(51) Int. Cl. F16F 9/34

(52) U.S. Cl. 188/282.1

(57) ABSTRACT

A vehicle damper includes a valve having a flanged spring seat for clamping a floating orifice disk to a valve seat. The flanged spring seat supports and aligns the orifice disk during assembly and operation of the valve. The valve may include a bushing having a guide surface piloted into the valve seat for guiding the floating orifice disk. Piloting the guide surface into the valve seat precludes pinching or clamping of the orifice disk between the bushing and the valve seat during assembly or operation of the valve. The valve may include a low rate, high preload spring, and the floating orifice disk may include openings for passage of fluid prior to the disk lifting off the valve seat, thereby providing a digressive valve operating characteristic. The valve may be used as either a compression or a rebound valve in a vehicle damper.

### RELATED APPLICATION

This application claims priority to United States Patent Application Serial No. 60/250,319 filed on Nov. 30, 2000 entitled “DIGRESSIVE PISTON COMPRESSION VALVE” by Jamshid K. Moradmand, et al, the entire disclosure of which is incorporated by reference, herein.

### TECHNICAL FIELD OF THE INVENTION

This invention relates to a damper adapted for use in a vehicle suspension system, and more particularly to a vehicle damper having a digressive blow-off compression valve including a floating orifice disk.

### BACKGROUND OF THE INVENTION

A hydraulic damper used in a vehicle suspension system, such as a shock absorber or a MacPherson strut, dissipates energy and filters out road inputs from being transferred to the vehicle body and the associated passenger compartment. Hydraulic dampers typically include a piston that is movable within a fluid filled working chamber of a cylinder. The cylinder is attached to one part of the suspension, and a piston rod extending from the piston and out of the cylinder is attached to another part of the vehicle suspension.

The piston of the damper separates the working chamber into a compression chamber and a rebound chamber. The piston is equipped with a sliding fluid seal that prevents leakage of the fluid around the piston, between the piston and the cylinder. The piston also includes one or more flow apertures extending though the piston that allow fluid in the working chamber to move between the compression and rebound chambers, as the piston rod and piston are moved in relation to the cylinder of the damper by movement of the vehicle suspension. The flow apertures extending through the piston are sized to restrict the flow of fluid through the piston, thereby limiting the rate at which the piston can move within the cylinder to be a function of how rapidly the fluid can pass through the flow apertures.

For improved performance, it is often desirable that the damper be tuned to provide different amounts of damping in the compression and rebound strokes, and that the amount of damping provided during either direction be capable of changing automatically depending upon the speed of piston movement required to accommodate movement of the suspension, under varying vehicle operating speeds and road conditions. To provide differing amounts of damping on the compression and rebound strokes of the damper, the piston may include a first set of flow apertures to restrict fluid flow through the piston in the compression direction, and a second set of flow apertures, having a different open area than the first set of flow apertures, to provide a different restriction to fluid flow through the piston in the rebound direction. The damper will then typically include one or more valves on the piston for blocking flow through either or both of the first and second sets of the flow apertures, so that fluid can flow through only one set of apertures at a time during movement of the piston. It is common to provide valves on both sides of the piston to selectively allow fluid flow through only the first set of flow apertures on the compression stroke, and through only the second set of flow apertures on the rebound stroke of the damper.

One type of valve used to provide block flow of fluid through one of the sets of flow apertures uses a valve seat, sometimes formed in one of the faces of the piston, having one or more pressure cavities in communication with one of the sets of flow apertures extending through the piston. A movable valve plate is clamped against the valve seat by a return spring. The fluid in the pressure cavities acts on the valve plate. When the fluid pressure in the pressure cavities, acting on the area of the valve plate exposed to the pressure, generates sufficient force to overcome the preload of the spring, the valve plate “blows-off” of the valve seat, and allows fluid to flow through the piston via the flow apertures and pressure cavities.

The return spring in this type of valve typically has a low spring rate, in the range of 6 to 8 Newtons per millimeter, for example, and provides only enough preload to return the valve plate to a seated position on the valve seat, after the fluid pressure acting against the valve plate is dissipated. The valve plate rapidly “blows-off” the valve seat, because once the valve plate lifts off the valve seat, the fluid pressure developed by the fluid trying to make its way through the piston acts, not just on the area of the valve plate closing off the pressure cavities, but over a much larger area of the valve plate facing the piston. Applying the pressure over this larger area, coupled with the low preload and spring rate of the return spring, causes the valve plate to move very rapidly off the valve seat once the preload of the return spring is overcome.

To provide different damping rates for slow and fast suspension inputs to the damper, it is also common practice to provide bleed passages through the valve plate that allow a small amount of flow through the piston via the flow apertures, pressure cavities, and bleed passages, before the valve plate blows-off of the valve seat. Such a valve provides a damper having a force versus velocity performance characteristic that follows a first progressive, generally parabolic shaped, curve during bleed flow, and second much flatter parabolic shaped progressive performance curve after the valve plate blows-off the seat. The term progressive as used herein is intended to convey a performance characteristic in which the force required to move the piston increases more rapidly than the corresponding increase in the velocity of the piston generating the force, as shown in FIG. 1. A blow off valve of the type described thus far is illustrated on the compression side of a damper piston in U.S. Pat. No. 5,738,190.

In some dampers, however, it is desired that the valve plate stay pressed against the valve seat until a much higher pressure is achieved in the pressure cavities, and then open so widely that the performance characteristic is digressive rather than progressive, as illustrated by the curve shown in FIG. 2. The term digressive as used herein is contemplated to encompass radical departures from the typical progressive curve described above, and particularly performance characteristics wherein the rate of change of force increases with increasing velocity of the piston, after the valve plate lifts off of the seat. Commonly assigned U.S. Pat. No. 5,921,360, to Moradmand, provides such a digressive blow-off rebound valve for a vehicle damper, by utilizing a special spring having a spring rate and a preload that are much higher than the spring rate and preload used in typical blow-off valves. The spring of Moradmand has a rate that is higher than prior blow-off valves, but is still quite low, thereby allowing the valve to open rapidly and to provide a significant change in flow area. Such a spring is generally longer than the springs used in prior valves.

Although the digressive blow-off valve of Moradmand works well for achieving its desired performance, the greater spring rate and preload of the spring, together with its larger size and greater length, can create difficulties in assembling certain embodiments of the valve using a floating orifice disk as a valve plate. It is desirable to use such a floating orifice disk, rather than incorporating bleed orifices into the spring seat or valve seat, as has been done in prior blow-off valves, because it is easier to accurately fabricate orifice disks with calibrated bleed passages than it is to accurately fabricate bleed passages incorporated into the spring seat or valve seat of the valve. In valves such as those taught in Moradmand, however, the greater spring rate and preload of the spring, together with its larger size and greater length, make it significantly more difficult to avoid inadvertently getting the floating orifice disk clamped between component parts of the valve during assembly of the damper, thereby rendering the disk immovable, or the disk can become cocked, pinched, or bent during assembly and operation, causing improper performance.

What is needed, therefore, is an improved valve assembly and vehicle damper that make use of a floating orifice plate in a manner that allows digressive blow-off performance, ensures proper alignment, and precludes damage or clamping of the floating orifice plate during assembly and operation of the valve.

### SUMMARY OF THE INVENTION

Our invention provides such an improved valve through the use of a flanged spring seat for clamping the floating orifice disk to the valve seat. The flanged spring seat provides improved support and alignment of the orifice disk during assembly and operation of the valve. The valve may also include a bushing having a guide surface piloted into the valve seat for guiding the floating orifice disk. Piloting the guide surface into the valve seat precludes pinching or clamping the orifice disk between the bushing and the valve seat during assembly or operation of the valve. The valve may include a low rate high preload spring, and the floating orifice disk may include openings for passage of fluid prior to the disk lifting off the valve seat, thereby providing a digressive valve operating characteristic. A valve according to our invention may be used as either a compression or a rebound valve in a vehicle damper.

In one form of our invention, a valve assembly is provided for a vehicle damper having a reciprocating piston and a piston rod connected to the piston for linear movement of the rod and piston along an axis, with the piston including a first and a second face and a flow aperture extending through the piston from the first to the second face. The valve assembly includes a valve seat oriented substantially perpendicularly to the axis and defining a pressure cavity in communication with the flow aperture extending through the piston. An orifice disk of the valve assembly is adapted for mating engagement with the valve seat to block flow through the flow aperture and pressure cavity when the orifice disk is mated with the valve seat. The orifice disk is movable along the axis in a direction away from the valve seat. A spring seat of the valve assembly is adapted for movement along the axis and for clamping the orifice disk against the valve seat. A spring preloads the spring seat and orifice disk against the valve seat.

The spring may be a low rate high preload spring. The spring may have a spring rate in the range of 20 to 60 Newtons per millimeter, and a preload in the range of 100 to 500 Newtons. The spring seat may include a radially extending flange extending generally perpendicularly to the axis and adapted for bearing against the orifice disk.

The valve may include a bushing extending from the valve seat along the axis. The bushing includes a guide surface for guiding the spring seat and orifice disk along the axis, and a flange for clamping the spring against the spring seat when the bushing is clamped against the valve seat. The guide surface of the bushing extends past the orifice disk when the bushing is clamped against the valve seat, and the valve seat includes a piloting recess for receipt of a portion of the guide surface extending past the orifice disk when the bushing is clamped against the valve seat. The bushing limits the preload on the spring, and the piloting recess facilitates assembly of the vehicle damper by precluding the possibility of the orifice disk being inadvertently clamped between the bushing and the valve seat.

The orifice disk may include openings allowing a restricted flow of fluid through the flow aperture in the piston and out of the pressure cavity when the orifice disk is clamped against the valve seat, thereby providing digressive valve performance.

The guide surface of the bushing may be a right circular cylinder concentric with the axis, terminating in the flange at one end and in a cylindrical pilot at the other end, and the piloting recess in the valve seat may be configured for receiving and positioning the cylindrical pilot radially and axially with respect to the axis and the valve seat. The guide surface of the bushing may have a length between the flange and cylindrical pilot selected for setting the preload on the spring to a predetermined range when the bushing is clamped against the valve seat with the cylindrical pilot seated in the piloting recess of the valve seat.

The valve seat may be formed by either the first or the second face of the piston. The valve assembly may be either a compression or a rebound valve.

The valve assembly may also include both a compression and a rebound valve. Where the valve seat is formed by the first face of the piston and the valve assembly is a compression valve assembly, the piston may include a second flow aperture, and the valve assembly may further include a rebound valve assembly including a second valve seat formed by the second face of the piston and oriented substantially perpendicularly to the axis and defining a second pressure cavity in communication with the second flow aperture extending through the piston. The rebound valve includes a second orifice disk adapted for mating engagement with the second valve seat to block flow through the second flow aperture and second pressure cavity when the second orifice disk is mated with the second valve seat, and movable along the axis in a direction away from the second valve seat. A second spring seat is adapted for movement along the axis and for clamping the second orifice disk against the second valve seat. A second spring preloads the second spring seat and second orifice disk against the second valve seat. The rebound valve further includes a second bushing extending from the second valve seat along the axis, with the second bushing including a guide surface for guiding the second spring seat and second orifice disk along the axis, and a flange for clamping the second spring against the second spring seat when the second bushing is clamped against the second valve seat. The guide surface of the second bushing extends past the second orifice disk when the second bushing is clamped against the second valve seat. The second valve seat includes a piloting recess for receipt of a portion of the guide surface of the second bushing extending past the second orifice disk when the second bushing is clamped against the second valve seat, the second bushing thereby limiting the preload on the second spring and the piloting recess of the second valve seat thereby facilitating assembly of the vehicle damper by precluding the second orifice disk from being inadvertently clamped between the second bushing and the second valve seat. The second orifice disk may include openings allowing a restricted flow of fluid through the flow second aperture in the piston and out of the second pressure cavity when the second orifice disk is clamped against the second valve seat, thereby providing digressive rebound valve performance.

Our invention may also be practiced in the form of a vehicle damper including one or more valves as described above. In one particular form, a vehicle damper according to our invention includes a cylinder tube defining a working chamber for containing a fluid therein and defining an axis. A reciprocating piston is slidably disposed in the working chamber. The piston includes a first and a second face and a flow aperture extending through the piston from the first to the second face. A piston rod has a first end connected to the piston for linear movement of the rod and piston within the working chamber along the axis. The second end of the piston rod extends along the axis and out of the working chamber. The vehicle damper further includes a valve assembly having a valve seat oriented substantially perpendicularly to the axis and defining a pressure cavity in communication with the flow aperture extending through the piston. An orifice disk is adapted for mating engagement with the valve seat to block flow through the flow aperture and pressure cavity when the orifice disk is mated with the valve seat. The orifice disk is movable along the axis in a direction away from the valve seat, and a spring seat is adapted for movement along the axis and for clamping the orifice disk against the valve seat. A spring preloads the spring seat and orifice disk against the valve seat.

The spring may be a low rate high preload spring. The spring may have a spring rate in the range of 20 to 60 Newtons per millimeter, and a preload in the range of 100 to 500 Newtons. The spring seat may include a radially extending flange extending generally perpendicularly to the axis and adapted for bearing against the orifice disk.

The valve may include a bushing extending from the valve seat along the axis, with the bushing having a guide surface for guiding the spring seat and orifice disk along the axis, and a flange for clamping the spring against the spring seat when the bushing is clamped against the valve seat. The guide surface of the bushing extends past the orifice disk when the bushing is clamped against the valve seat, and the valve seat includes a piloting recess for receipt of a portion of the guide surface extending past the orifice disk when the bushing is clamped against the valve seat. The bushing limits the preload on the spring and the piloting recess facilitates assembly of the vehicle damper by precluding the orifice disk from being inadvertently clamped between the bushing and the valve seat.

The orifice disk of the valve assembly in the vehicle damper may include openings allowing a restricted flow of fluid through the flow aperture in the piston and out of the pressure cavity when the orifice disk is clamped against the valve seat.

The foregoing and other features and advantages of our invention are apparent from the following detailed description of exemplary embodiments, read in conjunction with the accompanying drawings. The detailed description and drawings are merely illustrative of the invention rather than limiting, the scope of the invention being defined by the appended claims and equivalents thereof.

### BRIEF DESCRIPTION OF THE DRAWINGS

FIG. 1 is a graph illustrating the performance of a prior blow-off valve, in a vehicle damper, having a low rate low preload spring resulting in progressive performance;

FIG. 2 is a graph illustrating the performance of a prior blow-off valve, in a rebound valve of a vehicle damper, having a low rate high preload spring resulting in digressive performance;

FIG. 3 is a cross-sectional view of a first exemplary embodiment of a vehicle damper, having a compression valve in accordance with our invention;

FIG. 4 is an exploded perspective view of the embodiment of FIG. 1; and

FIG. 5 is a cross-sectional view of a second exemplary embodiment of a vehicle damper, having both a compression and a rebound valve in accordance with our invention.

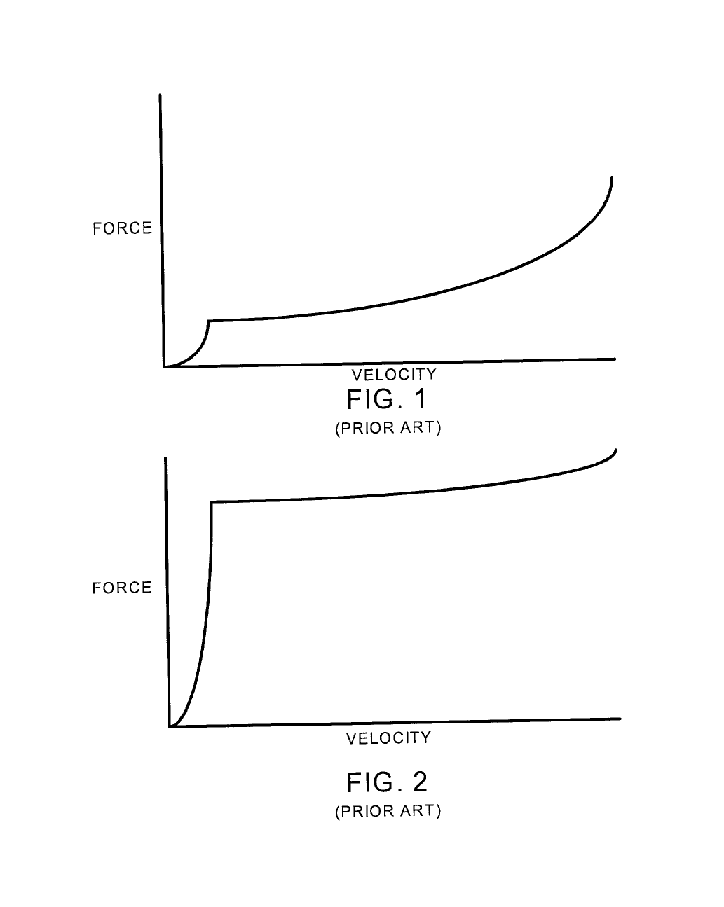

### DETAILED DESCRIPTION OF THE PRESENTLY PREFERRED EMBODIMENTS

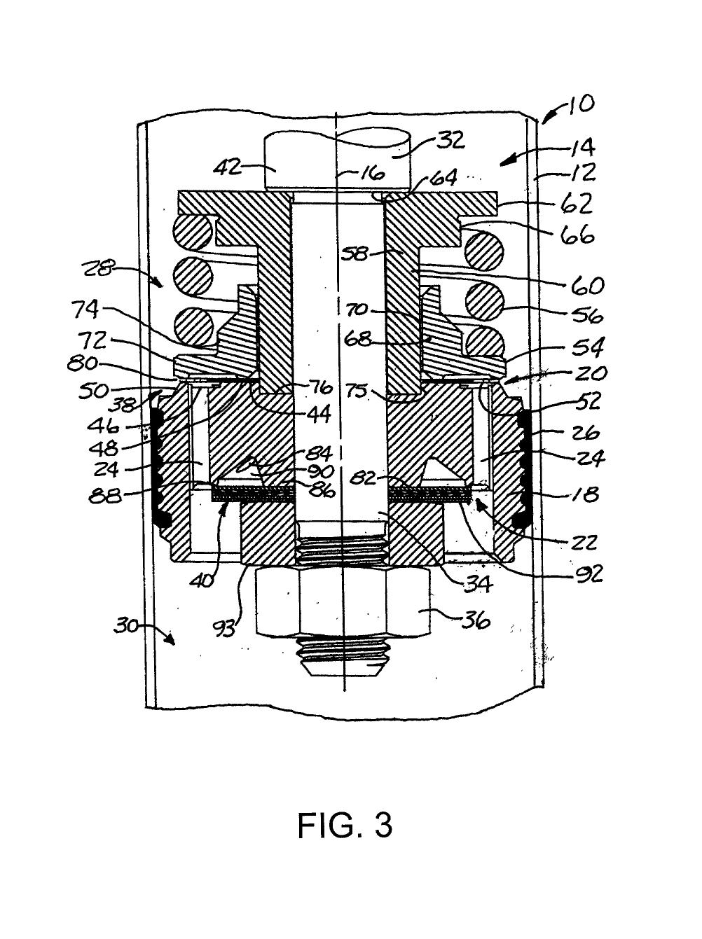

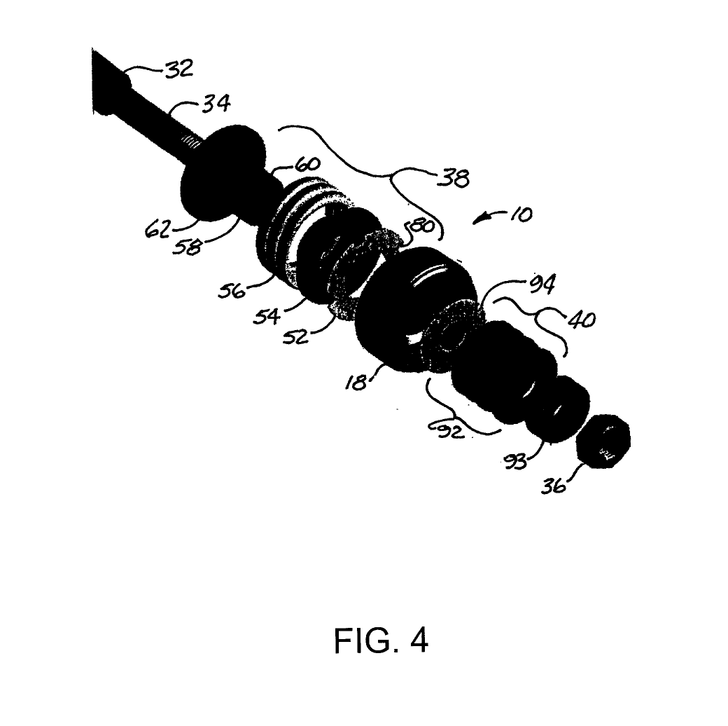

FIGS. 3 and 4 depict a vehicle damper 10 according to our invention including a cylinder tube 12 defining a working chamber 14 for containing a fluid therein and defining an axis 16, and a reciprocating piston 18 slidably disposed in the working chamber 14. The piston 18 includes a first and a second face 20, 22 and flow apertures 24 extending through the piston 18 from the first to the second face 20, 22. The piston has a seal ring 26 on the outer circumferential surface for providing a sliding seal between the piston 18 and the cylinder tube 12, such that the piston divides the working chamber 14 into an upper portion 28 above the piston 18 and a lower portion 30 below the piston 18.

A piston rod 32 has a first end 34 extending through a bore in the piston 18, and connected to the piston 18 by a nut 36 that clamps the piston 18 and parts of a compression valve 38 and a rebound valve 40 to the piston rod 32 for linear movement of the rod 32 and piston 18 within the working chamber 14 along the axis 16. The second end 42 of the piston rod 18 extends along the axis 16 and out of the working chamber 14.

The compression valve assembly 38 has a valve seat 44 formed by the first face 20 of the piston 18, oriented substantially perpendicularly to the axis 16. The valve seat 44 could also be a separate part bonded to the piston 18. The valve seat defines one or more pressure cavities 46 in fluid communication with the flow apertures 24 extending through the piston 18. The valve seat 44 also defines an inner hub 48 and an outer hub 50 surrounding the pressure cavities 46.

A floating orifice disk 52 is adapted for mating engagement with the inner and outer hubs 48, 50 of the valve seat 44 to block flow through the flow apertures 24 and pressure cavities 46 when the orifice disk 52 is mated with the valve seat 44. The orifice disk 52 is movable along the axis 16 in a direction away from the valve seat 44. A spring seat 54 is adapted for movement along the axis 16 and for clamping the orifice disk 52 against the valve seat 44.

A low rate/high preload precision wound helical spring 56 preloads the spring seat 54 and orifice disk 52 against the valve seat 44. We contemplate that such a spring 56, having characteristics suitable for use in a vehicle damper 10 according to our invention, would have a spring rate in the range of 20 to 60 Newtons per millimeter and develop a preload in the range of 100 to 500 Newtons, when installed in a valve as described herein. We contemplate that a suitable low rate high preload spring 56 might, for example, have a spring rate of approximately 45 Newtons per millimeter, and a preload of about 250 Newtons and above.

A bushing 58 extends from the valve seat 44 along the axis 16, with the bushing 58 including a guide surface 60 for guiding the spring seat 54 and orifice disk 52 along the axis 16, and a flange 62 for clamping the spring 56 against the spring seat 54 when the bushing 58 is clamped between a shoulder 64 on the piston rod 32 and the valve seat 44. The bushing also includes a spring guide 66 extending along the axis 16 from the flange 62 for engaging and centering the upper end of the spring 56.

The spring seat 54 also includes a hub 68 extending upward from the seat 54. The hub 68 has an elongated inner bore 70 configured for keeping the spring seat 54 in sliding alignment with the guide surface 60 of the bushing 58. The spring seat 54 also has a flange 72 for engaging the end of the spring 56 and an outer surface 74 extending into the spring 56 along the axis 16 from the flange 72 for engaging and centering the lower end of the spring 56. The flange 72 also supports the orifice disk 52 when it is floating off of the valve seat 44, and keeps the orifice disk 52 aligned properly in a generally perpendicular extending direction with respect to the axis 16 as the orifice disk 52 comes into contact with the valve seat 44, so that the orifice disk 52 does not become cocked or pinched during assembly and operation of the vehicle damper 10.

The guide surface 60 of the bushing 58 extends past the orifice disk 52 when the bushing 58 is clamped against the valve seat 44. The guide surface of the bushing 58, in the embodiment depicted in FIGS. 3-5, is a right circular cylinder, concentric with the axis 16, terminating in the flange 62 at one end and in a cylindrical pilot 75 at the other end.

The inner hub 48 of the valve seat 44 includes a piloting recess 76 for receipt of the cylindrical pilot 75 of the guide surface 60 extending past the orifice disk 52 when the bushing 58 is clamped against the valve seat 44. The piloting recess 76 in the valve seat 44 is configured for receiving and positioning the cylindrical pilot 75 radially and axially, with respect to the axis 16 and the valve seat 44. With the end of the bushing 58 inserted and clamped into the piloting recess 76, the length of the bushing 58 between the flange 62 and the pilot 75 limits the preload on the spring 56. Preferably, the guide surface 60 is long enough to extend past the orifice disk 52 into the piloting recess 76 prior to clamping up the compression valve assembly 38, so that the orifice disk 52 cannot be inadvertently clamped between the pilot 75 of the bushing 58 and the valve seat 44.

The outer periphery of the orifice disk 52 includes slotted openings 80 extending over the pressure cavities 46 and configured for allowing a restricted flow of fluid through the flow aperture 24 in the piston 18 and out of the pressure cavities 46 when the orifice disk 52 is clamped against the valve seat 44, to thereby provide a digressive operating characteristic for the compression valve 38. By varying the size and number of the slotted openings 80, a desired low speed performance characteristic of the vehicle damper 10 can be achieved. The pressure at which the compression valve 38 will blow off can be preset by judicious selection of the preload and rate of the spring 56, and the areas of the orifice disk 52 exposed to the fluid pressure in the pressure cavities 46 when the orifice disk 52 is clamped against the valve seat 44. The high speed travel rate of the piston 18 in the working chamber 14 after blow-off has occurred is determined by the size and number of the flow apertures 24 extending through the piston 18.

In the embodiments depicted in FIGS. 3 and 4, the rebound valve 40 is a flexing disk valve. The second face 22 of the piston 18 is configured to provide a second valve seat 82 and the piston 18 defines one or more second flow apertures 84 extending through the piston 18. The second valve seat 82 defines a second inner hub 86 and a second outer hub 88 surrounding one or more second pressure cavities 90 connected in fluid communication with the second flow apertures 84.

A series of flexible washers 92 are clamped against the second valve seat 82 by a retainer/spacer 93, having a radiused upper surface adjacent the flexing disks 92, and the nut 36. The outer periphery of the washer 92 closest to the second valve seat 82 includes notched openings 94 to allow a flow of fluid across the piston 18 during low speed rebound through the second flow apertures 84 and second pressure cavities 90. Fluid pressure transferred to the second pressure cavities 90 via the second flow apertures 84 causes the flexible washers 92 to flex away from the outer hub 88 of the second valve seat 82 when the pressure exceeds a predetermined preload value set by the material, configuration and number of flexible disks 92 used in the rebound valve 40. As the washers 92 flex away from the outer hub 88 of the second valve seat 82, the flow area through the rebound valve 40 is increased significantly, thereby allowing for less damping at high velocities of the piston 18. The radius on the retainer/spacer 93 is judiciously selected to prevent over-flexing of the washers 92.

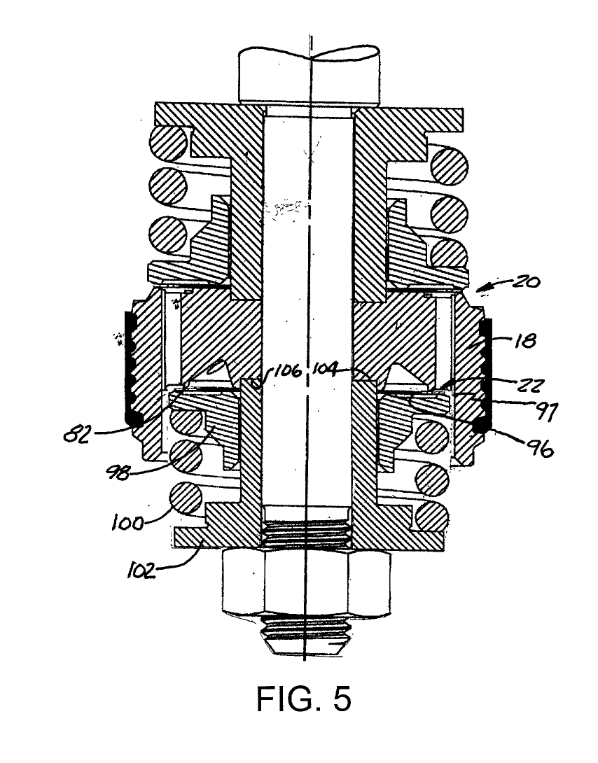

We contemplate that in some forms of our invention, it may be desirable to utilize a valve assembly according to our invention, as described above, located on the second face 22 of the piston and configured as a rebound valve, with some other form of a compression valve being used on the first face 20 of the piston 18. We further contemplate that in other forms of our invention, it may be desirable to utilize a valve assembly according to our invention on both faces 20, 22 of the piston, as depicted in FIG. 5. In the embodiment depicted in FIG. 5, a second orifice disk 96, with notches 97 in the outer periphery thereof, is clamped against the second valve seat 82 by a second spring seat 98, second spring 100, and a second bushing 102, in the same manner as disclosed above with regard to the embodiments of the compression valve 38 depicted in FIGS. 3 and 4. The second valve may also include clamping the pilot end 104 of the second bushing 102 within a piloting recess 106, as depicted in FIG. 5, to preclude pinching or clamping the second orifice disk 96 between the second valve seat 82 and the pilot end 104 of the second bushing 102.

While the embodiments of our invention disclosed herein are presently considered to be preferred, various changes and modifications can be made without departing from the spirit and scope of the invention. The term “vehicle damper,” as used herein, is intended to include, inter alia, structures known in the automotive or vehicle manufacturing industry as “shock absorbers,” and “MacPherson struts.”

The scope of the invention is indicated in the appended claims. We intend that all changes or modifications within the meaning and range of equivalents are embraced by the claims.

We claim:

1. A valve assembly for a vehicle damper, the vehicle damper having a reciprocating piston and a piston rod connected to the piston for linear movement of the rod and piston along an axis, the piston including a first and a second face and a flow aperture extending through the piston from the first to the second face, the valve assembly comprising:
a valve seat oriented substantially perpendicularly to the axis and defining a pressure cavity in communication with the flow aperture extending through the piston;
an orifice disk adapted for mating engagement with the valve seat to block flow through the flow aperture and the pressure cavity when the orifice disk is mated with the valve seat, and movable along the axis in a direction away from the valve seat;
a spring seat adapted for movement along the axis and for clamping the orifice disk against the valve seat; and
a spring for preloading the spring seat and orifice disk against the valve seat.

2. The valve assembly of claim 1 wherein the spring is a low rate high preload spring.

3. The valve assembly of claim 2 wherein the spring has a spring rate in the range of 20 to 60 Newtons per millimeter, and the spring has a preload in the range of 100 to 500 Newtons.

4. The valve assembly of claim 1 wherein the spring seat includes a radially extending flange extending generally perpendicularly to the axis and adapted for bearing against the orifice disk.

5. The valve assembly of claim 1 wherein the orifice disk includes openings allowing a restricted flow of fluid through the flow aperture in the piston and out of the pressure cavity when the orifice disk is clamped against the valve seat.

6. The valve assembly of claim 1 further comprising:
a bushing extending from the valve seat along the axis, the bushing including a guide surface, for guiding the spring seat and orifice disk along the axis, and a flange for clamping the spring against the spring seat when the bushing is clamped against the valve seat;
the guide surface of the bushing extending past the orifice disk when the bushing is clamped against the valve seat, and the valve seat including a piloting recess for receipt of a portion of the guide surface extending past the orifice disk when the bushing is clamped against the valve seat, the bushing thereby limiting the preload on the spring and the piloting recess thereby facilitating assembly of the vehicle damper by precluding the orifice disk from being inadvertently clamped between the bushing and the valve seat.

7. The valve assembly of claim 6 wherein:
the guide surface of the bushing is a right circular cylinder concentric with the axis, terminating in the flange at one end and in a cylindrical pilot at the other end; and
the piloting recess in the valve seat is configured for receiving and positioning the cylindrical pilot radially and axially with respect to the axis and the valve seat.

8. The valve assembly of claim 7 wherein the guide surface of the bushing has a length between the flange and cylindrical pilot selected for setting the preload on the spring to a predetermined range when the bushing is clamped against the valve seat with the cylindrical pilot seated in the piloting recess of the valve seat.

9. The valve assembly of claim 1 wherein the valve seat is formed by the first face of the piston.

10. The valve assembly of claim 9 wherein the valve assembly is a compression valve assembly.

11. The valve assembly of claim 1 wherein the valve seat is formed by the second face of the piston.

12. The valve assembly of claim 11 wherein the valve assembly is a rebound valve assembly.

13. The valve assembly of claim 1 wherein the valve seat is formed by the first face of the piston and the valve assembly is a compression valve assembly, the piston includes a second flow aperture, and the valve assembly further includes a rebound valve assembly comprising:
a second valve seat formed by the second face of the piston and oriented substantially perpendicularly to the axis and defining a second pressure cavity in communication with the second flow aperture extending through the piston;
a second orifice disk adapted for mating engagement with the second valve seat to block flow through the second flow aperture and second pressure cavity when the second orifice disk is mated with the second valve seat, and movable along the axis in a direction away from the second valve seat;
a second spring seat adapted for movement along the axis and for clamping the second orifice disk against the second valve seat; and
a second spring for preloading the second spring seat and second orifice disk against the second valve seat.

14. The valve assembly of claim 13 wherein the second orifice disk includes openings allowing a restricted flow of fluid through the flow second aperture in the piston and out of the second pressure cavity when the second orifice disk is clamped against the second valve seat.

15. A vehicle damper, comprising:
a cylinder tube defining a working chamber for containing a fluid therein and defining an axis;
a reciprocating piston slidably disposed in the working chamber and including a first and a second face and a flow aperture extending through the piston from the first to the second face;
a piston rod having a first and a second end, the first end connected to the piston for linear movement of the rod and piston within the working chamber along the axis, the second end of the piston rod extending along the axis and out of the working chamber; and
a valve assembly comprising:
a valve seat oriented substantially perpendicularly to the axis and defining a pressure cavity in communication with the flow aperture extending through the piston;
an orifice disk adapted for mating engagement with the valve seat to block flow through the flow aperture and pressure cavity when the orifice disk is mated with the valve seat, and movable along the axis in a direction away from the valve seat;
a spring seat adapted for movement along the axis and for clamping the orifice disk against the valve seat; and
a spring for preloading the spring seat and orifice disk against the valve seat.

16. The vehicle damper of claim 15 wherein the orifice disk includes openings allowing a restricted flow of fluid through the flow aperture in the piston and out of the pressure cavity when the orifice disk is clamped against the valve seat.

17. The vehicle damper of claim 15 wherein the spring is a low rate high preload spring.

18. The vehicle damper of claim 17 wherein the spring has a spring rate in the range of 20 to 60 Newtons per millimeter, and the spring has a preload in the range of 100 to 500 Newtons.

19. The vehicle damper of claim 15 wherein the spring seat includes a radially extending flange extending generally perpendicularly to the axis and adapted for bearing against the orifice disk.

20. The vehicle damper of claim 15 further comprising:
a bushing extending from the valve seat along the axis, the bushing including a guide surface, for guiding the spring seat and orifice disk along the axis, and a flange for clamping the spring against the spring seat when the bushing is clamped against the valve seat;
the guide surface of the bushing extending past the orifice disk when the bushing is clamped against the valve seat, and the valve seat including a piloting recess for receipt of a portion of the guide surface extending past the orifice disk when the bushing is clamped against the valve seat, the bushing thereby limiting the preload on the spring and the piloting recess thereby facilitating assembly of the vehicle damper by precluding the orifice disk from being inadvertently clamped between the bushing and the valve seat.

21. The vehicle damper of claim 20 wherein:
the guide surface of the bushing is a right circular cylinder concentric with the axis, terminating in the flange at one end and in a cylindrical pilot at the other end; and
the piloting recess in the valve seat is configured for receiving and positioning the cylindrical pilot radially and axially with respect to the axis and the valve seat.

22. The vehicle damper of claim 21 wherein the guide surface of the bushing has a length between the flange and cylindrical pilot selected for setting the preload on the spring to a predetermined range when the bushing is clamped against the valve seat with the cylindrical pilot seated in the piloting recess of the valve seat.

23. The vehicle damper of claim 15 wherein the valve seat is formed by the first face of the piston.

24. The vehicle damper of claim 23 wherein the piston divides the working chamber into an upper rebound portion partially bounded by the first face of the piston and a lower compression portion partially bounded by the second face of the piston, and the valve assembly is a compression valve.

25. The vehicle damper of claim 20 wherein the valve seat is formed by the second face of the piston.

26. The vehicle damper of claim 25 wherein the piston divides the working chamber into an upper rebound portion partially bounded by the first face of the piston and a lower compression portion partially bounded by the second face of the piston, and wherein the valve assembly is a rebound valve assembly.

27. The vehicle damper of claim 20 wherein the valve seat is formed by the first face of the piston and the valve assembly is a compression valve assembly, the piston includes a second flow aperture, and the valve assembly further includes a rebound valve assembly comprising:
a second valve seat formed by the second face of the piston and oriented substantially perpendicularly to the axis and defining a second pressure cavity in communication with the second flow aperture extending through the piston;
a second orifice disk adapted for mating engagement with the second valve seat to block flow through the second flow aperture and the second pressure cavity when the second orifice disk is mated with the second valve seat, and movable along the axis in a direction away from the second valve seat;
a second spring seat adapted for movement along the axis and for clamping the second orifice disk against the second valve seat; and
a second spring for preloading the second spring seat and second orifice disk against the second valve seat.

28. The vehicle damper of claim 27 wherein the second orifice disk includes openings allowing a restricted flow of fluid through the second flow aperture in the piston and out of the second pressure cavity when the second orifice disk is clamped against the second valve seat.
